(19) United States
(12) Patent Application Publication
(10) Pub. No.: US 2026/0117708 A1
(43) Pub. Date: Apr. 30, 2026

(54) POWER TRANSFER SYSTEM

(71) Applicants: General Electric Company, Evendale, OH (US); General Electric Deutschland Holding GmbH, Frankfurt (DE)

(72) Inventors: Pushkar Chandrakant Chaudhari, Bengaluru (IN); Mohamed Osama, Garching (DE)

(21) Appl. No.: 19/283,378

(22) Filed: Jul. 29, 2025

(30) Foreign Application Priority Data
Oct. 28, 2024 (IN) 202411082271

(51) Int. Cl. F02C 7/36; F01D 15/10; H02K 7/18; H02K 7/20; H02K 11/04

(52) U.S. Cl. CPC F02C 7/36; F01D 15/10; H02K 7/1823; H02K 7/20; H02K 11/04

(57) ABSTRACT

A power transfer system includes a first pressure spool of a gas turbine engine structured to rotate and compress a working fluid to a first pressure, a first electric machine connected to the first pressure spool, the first electric machine including a first stator, a second pressure spool of the gas turbine engine structured to rotate and compress the working fluid to a second pressure different than the first pressure, a second electric machine connected to the second pressure spool, the second electric machine including a second stator, a first power converter connected to one of the first electric machine or the second electric machine, and an electrical connector including a main portion connecting the first stator of the first electric machine to the second stator of the second electric machine while bypassing the first power converter and a branch portion connecting the main portion to the first power converter.

### PRIORITY INFORMATION

The present application claims priority to Indian Patent Application Serial Number 202411082271 filed on Oct. 28, 2024.

### FIELD

The present disclosure relates to a power transfer system for pressure spools of a gas turbine engine.

### BACKGROUND

Aeronautical vehicles use a variety of power sources to drive one or more propulsors that may generate thrust for the vehicles. Many vehicles use gas turbine engines, having two or more spools of a turbomachine which may include one or more electric machines that operate with the spools. For example, an electric machine can be driven by a high pressure spool of the gas turbine engine to generate an electric power that can be used elsewhere in the aeronautical vehicle. While gas turbine engines have advanced significantly over the years, it may be beneficial to examine inclusion of other electric machines with the gas turbine engine. Improvements to the integration of electric machines would be useful in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of an example gas turbine engine.

FIG. 2 is a schematic view of an example power transfer system for electric machines of the gas turbine engine.

FIG. 3 is a schematic view of the example power transfer system where a low pressure spool is connected to a doubly fed machine.

FIG. 4 is a schematic view of another example power transfer system where a high pressure spool is connected to a doubly fed machine.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

As used herein, the terms “first,” “second,” “third,” and other ordinals are used to distinguish one component from another and are not intended to signify location or importance of the individual components.

The present disclosure is generally related to a power transfer system for a gas turbine engine, in which the gas turbine engine includes two or more spools (e.g., two or more shafts respectively connecting two or more turbine and compressor elements). An electric machine can be coupled to a first pressure spool of the gas turbine engine (e.g., a high pressure shaft rotatingly coupled to a high pressure compressor and high pressure turbine). The electric machine can be configured to operate as a generator in which mechanical power is extracted from the first pressure spool and converted into electric power. The electric machine (also referred to herein as a first electric machine) can transfer the electric power to a second electric machine that is coupled to a second pressure spool of the gas turbine engine (e.g., a low pressure shaft rotatingly coupled to a low pressure compressor and low pressure turbine).

When the second electric machine is a doubly fed electric machine, the first electric machine transfers at least some of the electric power directly to the second electric machine. That is, the stator windings of the first electric machine and the second electric machine are connected to each other with no power converters in between, providing a direct power transfer path between the first and second pressure spools. This direct coupling increases power transfer efficiency from the first electric machine to the second electric machine.

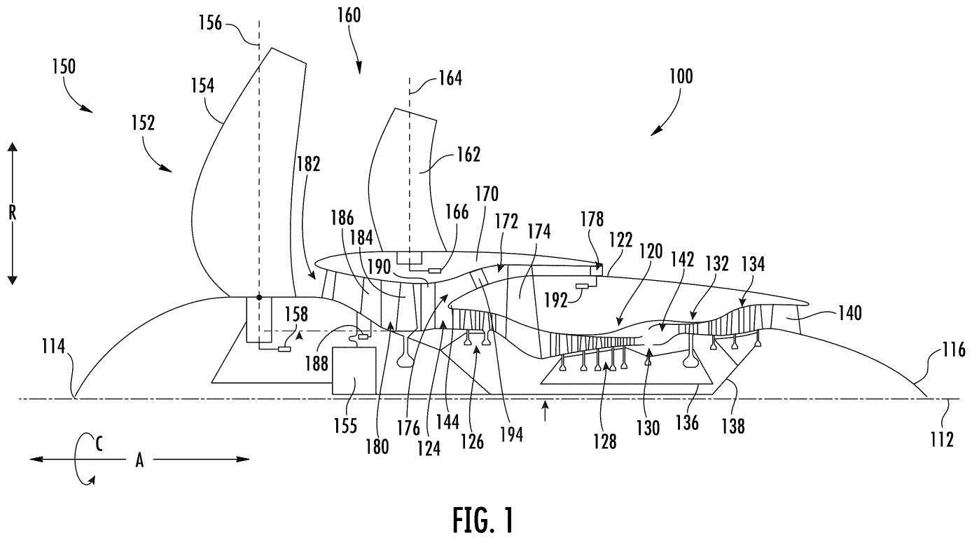

Referring now to FIG. 1, a schematic cross-sectional view of a gas turbine engine 100 is provided according to an example embodiment of the present disclosure. Particularly, FIG. 1 provides an engine having a rotor assembly with a single stage of unducted rotor blades. In such a manner, the rotor assembly may be referred to herein as an “unducted fan,” or the entire engine may be referred to as an “unducted engine.” In addition, the gas turbine engine 100 of FIG. 1 includes a third stream extending from the compressor section to a rotor assembly flowpath over the turbomachine, as will be explained in more detail below.

For reference, the gas turbine engine 100 defines an axial direction A, a radial direction R, and a circumferential direction C. Moreover, the gas turbine engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The gas turbine engine 100 extends between a forward end 114 and an aft end 116, e.g., along the axial direction A.

The gas turbine engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor (referred to as an LP compressor 126 herein) for pressurizing the air that enters the turbomachine 120 through the annular core inlet 124. A high pressure (“HP”), multi-stage, axial-flow compressor (referred to as an HP compressor 128 herein) receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to an HP turbine 132. The HP turbine 132 drives the HP compressor 128 through an HP shaft 136. In this regard, the HP turbine 132 is drivingly coupled with the HP compressor 128. The high energy combustion products then flow to an LP turbine 134. The LP turbine 134 drives the LP compressor 126 and components of the fan section 150 through an LP shaft 138. In this regard, the LP turbine 134 is drivingly coupled with the LP compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140. The LP compressor 126, LP turbine 134, and LP shaft 138 are generally referred to as an “LP spool” of the gas turbine engine 100. The HP compressor 128, HP turbine 132, and HP shaft 136 are generally referred to as an “HP spool” of the gas turbine engine 100.

Accordingly, the turbomachine 120 defines a working gas flowpath or core duct 142 that extends between the annular core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a fan 152, which is the primary fan in this example embodiment. For the depicted embodiment of FIG. 1, the fan 152 is an open rotor or unducted fan 152. In such a manner, the gas turbine engine 100 may be referred to as an open rotor engine.

As depicted, the fan 152 includes an array of fan blades 154 (only one shown in FIG. 1). The fan blades 154 are rotatable, e.g., about the longitudinal axis 112. As noted above, the fan 152 is drivingly coupled with the LP turbine 134 via the LP shaft 138. For the embodiments shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. Each fan blade 154 has a root and a tip and a span defined therebetween. Each fan blade 154 defines a central blade axis 156. For this embodiment, each fan blade 154 of the fan 152 is rotatable about its central blade axis 156, e.g., in unison with one another. One or more actuators 158 are provided to facilitate such rotation and therefore may be used to change a pitch of the fan blades 154 about their respective central blades' axes 156.

The fan section 150 further includes a fan guide vane array 160 that includes fan guide vanes 162 (only one shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the fan 152, which is unducted, a ducted fan 184 is included aft of the fan 152, such that the gas turbine engine 100 includes both a ducted and an unducted fan which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The ducted fan 184 is, for the embodiment depicted, driven by the LP turbine 134 (e.g. coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like.

The ducted fan 184 includes a plurality of fan blades (not separately labeled in FIG. 1) arranged in a single stage, such that the ducted fan 184 may be referred to as a single stage fan. The fan blades of the ducted fan 184 can be arranged in equal spacing around the longitudinal axis 112. Each blade of the ducted fan 184 has a root and a tip and a span defined therebetween.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the gas turbine engine 100.

Incoming air may enter the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a fan duct splitter or leading edge 144 of the core cowl 122 and may partially co-extend generally axially on opposite radial sides of the core cowl 122.

The gas turbine engine 100 also defines or includes an inlet duct 180. The inlet duct 180 extends between an engine inlet 182 and the annular core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by the fan duct splitter or leading edge 144 of the core cowl 122. In the embodiment depicted, the inlet duct 180 is wider than the core duct 142 along the radial direction R. The inlet duct 180 is also wider than the fan duct 172 along the radial direction R.

Notably, for the embodiment depicted, the gas turbine engine 100 includes one or more features to increase an efficiency of a third stream thrust (e.g., a thrust generated by an airflow through the fan duct 172 exiting through the fan exhaust nozzle 178, generated at least in part by the ducted fan 184). In particular, the gas turbine engine 100 further includes an array of inlet guide vanes 186 positioned in the inlet duct 180 upstream of the ducted fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the ducted fan 184 and upstream of the fan duct inlet 176, the gas turbine engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the gas turbine engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust during one or more engine operating conditions. Further, by introducing a variability in the geometry of the inlet guide vanes 186 and the fan exhaust nozzle 178, the gas turbine engine 100 may be capable of generating more efficient third stream thrust across a relatively wide array of engine operating conditions, including takeoff and climb (where a maximum total engine thrust is generally needed) as well as cruise (where a lesser amount of total engine thrust is generally needed).

Moreover, referring still to FIG. 1, in exemplary embodiments, air passing through the fan duct 172 may be relatively cooler (e.g., lower temperature) than one or more fluids utilized in the turbomachine 120. In this way, one or more heat exchangers 194 may be positioned in thermal communication with the fan duct 172. For example, one or more heat exchangers 194 may be disposed within the fan duct 172 and utilized to cool one or more fluids from the core engine with the air passing through the fan duct 172, as a resource for removing heat from a fluid (e.g., compressor bleed air, oil or fuel).

Although not depicted, the heat exchanger 194 may be an annular heat exchanger extending substantially 360 degrees in the fan duct 172 (e.g., at least 300 degrees, such as at least 330 degrees). In such a manner, the heat exchanger 194 may effectively utilize the air passing through the fan duct 172 to cool one or more systems of the gas turbine engine 100 (e.g., lubrication oil systems, compressor bleed air, electrical components, etc.). The heat exchanger 194 uses the air passing through the fan duct 172 as a heat sink and correspondingly increases the temperature of the air downstream of the heat exchanger 194 and exiting the fan exhaust nozzle 178.

It will be appreciated, however, that the exemplary gas turbine engine 100 is provided by way of example only. In other exemplary embodiments, the gas turbine engine 100 may have any other configuration. For example, in other exemplary embodiments, the turbomachine 120 may have any other number and arrangement of shafts, spools, compressors, turbines, etc. Further, in other exemplary embodiments, the gas turbine engine 100 may alternatively be configured as a ducted turbofan engine (including an outer nacelle surrounding the fan 152 and a portion of the turbomachine 120); as a direct drive gas turbine engine (may not include a reduction gearbox, such as the speed reduction gearbox 155); as a fixed pitch gas turbine engine (may not include a variable pitch fan, such as fan 152); as a two-stream gas turbine engine (may not include the fan duct 172); etc.

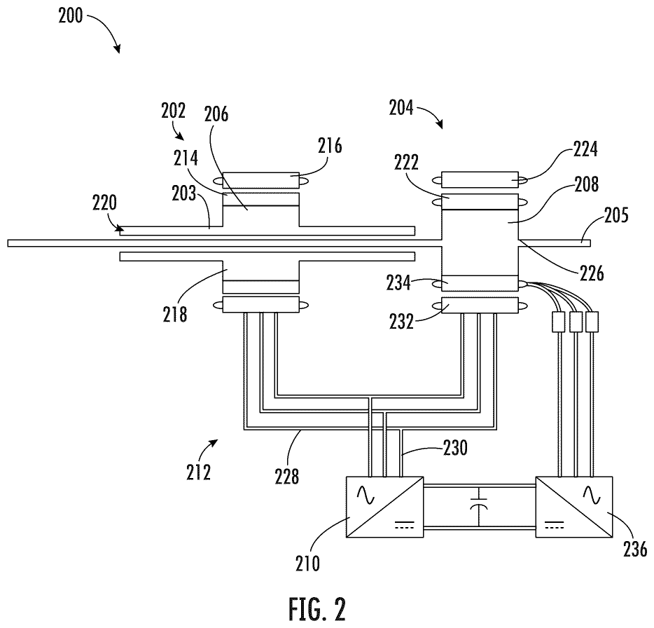

Now referring to FIG. 2, a power transfer system 200 for a gas turbine engine 100 is shown. The power transfer system 200 includes a first pressure spool 202, a second pressure spool 204, a first electric machine 206, a second electric machine 208, a first power converter 210 connecting the first electric machine 206 to the second electric machine 208, and an electrical connector 212. The power transfer system 200 transfers power from one of the first and second pressure spools 202, 204 to the other of the first and second pressure spools 202, 204. More specifically, the power transfer system 200 is useful to extract mechanical power from one spool of the gas turbine engine 100 and transfer the mechanical power to another spool of the gas turbine engine 100 via an electromagnetic interaction as will be discussed further below. When the gas turbine engine 100 includes the first and second electric machines 206, 208, the gas turbine engine 100 may be a “hybrid-electric” gas turbine engine.

The first pressure spool 202 is structured to rotate and compress a working fluid to a first pressure, thereby generating mechanical power. In the example of FIG. 2, the first pressure spool 202 is a high pressure (HP) spool that includes the HP compressor 128, the HP turbine 132, and the HP shaft 136. In such a form, a first pressure shaft 203 of the first pressure spool 202 corresponds to the HP shaft 136.

The first electric machine 206 is electrically connected to the first pressure spool 202. The first electric machine 206 includes a first stator 214 having at least one first winding 216, and a first rotor 218 having at least one first permanent magnet (not shown in FIG. 2). The first stator 214 can be fixed to the gas turbine engine 100 such that it remains stationary relative to the rotating HP shaft 136. When operated as an electric generator, the first rotor 218 is configured to rotate in response to rotation of the HP shaft 136, where relative rotation of the at least one first permanent magnet induces, via an electromagnetic interaction of the first stator 214 with the first rotor 218, an electric current in the at least one first winding of the first electric machine 206. Thus, mechanical power from the first pressure spool 202 is converted into electrical power. When operated as an electric motor, excitation of the at least one first winding 216 generates a magnetic field which interacts with the magnetic field of the at least one first permanent magnet 146. Interaction of the magnetic field creates a force upon the at least one first permanent magnet 146 which, in turn, creates a reactive force upon the HP shaft 136. The HP shaft 136 can be accelerated by using the first electric machine 206 as a motor, and can be decelerated by using the first electric machine 206 as a generator.

The second pressure spool 204 of the gas turbine engine 100 is structured to rotate and compress the working fluid to a second pressure different than the first pressure, thereby generating mechanical power. In the example of FIG. 2, the second pressure spool 204 is a low pressure (LP) spool that includes the LP compressor 126, the LP turbine 134, and the LP shaft 138. In such a form, a second pressure shaft 205 of the second pressure spool 204 corresponds to the LP shaft 138. The first pressure shaft 203 and the second pressure shaft 205 are concentric about a common axis. Specifically, the first pressure shaft 203 is radially outward from the second pressure shaft 205 such that the second pressure shaft 205 rotates within a cavity 220 defined by the first pressure shaft 203.

It will be appreciated that the use of “first” and “second” with respect to the pressure spools is descriptive to either the HP spool or the LP spool. That is, the first pressure spool 202 may be either the HP spool or the LP spool, and the second pressure spool 204 is the other of the HP spool or the LP spool.

The second electric machine 208 is electrically connected to the second pressure spool 204. The second electric machine 208 includes a second stator 222 having at least one second winding 224, and a second rotor having 226 at least one second permanent magnet (not shown). The second stator 222 can be fixed to the gas turbine engine 100 such that it remains stationary relative to the rotating LP shaft 138. As with the first electric machine 206, the second electric machine 208 may be driven by the second pressure spool 204 to convert mechanical power into electrical power.

The first electric machine 206 is connected to the second electric machine 208 by the electrical connector 212. The electrical connector 212 includes a main portion 228 connecting the first stator 214 of the first electric machine 206 to the second stator 222 of the second electric machine 208. In particular, the main portion 228 of the electrical connector 212 directly connects the first stator 214 to the second stator 222 to transfer power between the first and second electric machines 206, 208, bypassing the first power converter 210. The electrical connector 212 includes a branch portion 230 connecting the main portion 228 to the first power converter 210. In such a form, power transfers from the first electric machine 206 to the second electric machine 208 without the use of the first power converter 210, and the first power converter 210 can be selected with a lower power rating that the total amount of power transferred. That is, the main portion 228 is configured to transfer more power between the first and second electric machines 206, 208 than the first power converter 210.

One of the first electric machine 206 or the second electric machine 208 is a doubly fed electric machine including a first set of windings and a second set of windings. In the example of FIG. 2, the second electric machine 208 is the doubly fed electric machine (DFM), and the at least one second winding 224 includes a first set of second windings 232 and a second set of second windings 234. In particular, the second set of second windings 234 may be accessed through slip rings. The other of the first or second electric machines 206, 208 can be a permanent magnet synchronous machine (PMSM).

The power transfer system 200 may include a second power converter 236 electrically connected to the one of the first stator 214 or the second stator 222. In particular, the second power converter 236 may be connected to the one of the first and second electric machines 206, 208 that is the DFM. In such a form, the main portion 228 of the electrical connector 212 is connected to the first set of windings (e.g., the first set of second windings 232 in FIG. 2) and the second power converter 236 is connected to the second set of windings (e.g., the second set of second windings 234 in FIG. 2). In such a form, the second set of windings is connected to the second rotor 226 via slip rings (not shown). The first power converter 210 and the second power converter 236 may be alternating current/alternating current (AC/AC) electric converters configured to transmit alternating current. Additionally, the second power converter 236 may be current-controlled.

As a DFM, the second electric machine 208 is configured to output a constant voltage when a rotational speed of the first pressure spool 202 changes. More specifically, as a rotation speed of the second rotor 226 changes, a current in the second stator 222 (provided by the electrical connector 212) is adjusted such that current output from the second electric machine 208 is a constant current. In particular, variations in current from the second electric machine 208 are reduced by slip power provided from the first electric machine 206 by the second power converter 236. Because the amount of slip power to maintain output of the constant current is much lower than the overall amount of power output by the second electric machine 208, the first power converter 210 and the second power converter 236 may be rated for lower voltages than a conventional assembly where all of the power is transmitted through the first power converter 210 and the second power converter 236.

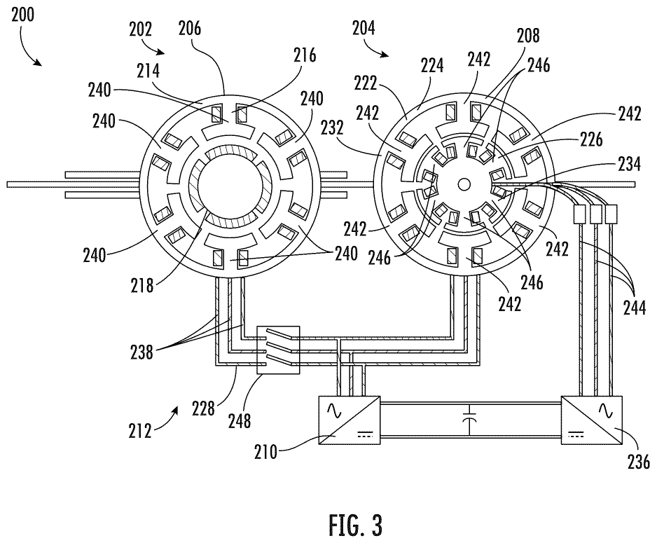

Now referring to FIG. 3, a schematic view of the power transfer system 200 of FIG. 2 is shown. Specifically, the first pressure spool 202 is an HP spool, the second pressure spool 204 is an LP spool, the first electric machine 206 is a PMSM, and the second electric machine 208 is a DFM. The main portion 228 of the electrical connector 212 connects the first electric machine 206 directly to the second electric machine 208, and the branch portion 230 connects the first electric machine 206 to the first power converter 210. The second power converter 236 is connected to the second electric machine 208 and to the first power converter 210.

In particular, the first electric machine 206 includes the first stator 214 and the first rotor 218, and a plurality of wires 238 of the electrical connector 212 are connected to the first stator 214. Specifically, each of the plurality of wires 238 is connected the one or more first windings 216 of the first stator 214 at respective attachment points 240. The first rotor 218 is rotatable within the first stator 214 to generate or receive electric power.

The second electric machine 208 includes the second stator 222 and the second rotor 226. The main portion 228 of the electrical connector 212 is connected to the second stator 222. Specifically, the plurality of wires 238 of the electrical connector 212 are connected to one or more of the second windings 224 of the second stator 222 at respective attachment points 242. The second power converter 236 includes a plurality of wires 244 that are connected to the second rotor 226 at respective attachment points 246.

The power transfer system 200 may include a circuit breaker 248. The circuit breaker 248 disconnects the first electric machine 206 from the second electric machine 208 when a current in the main portion 228 of the electrical connector 212 exceeds a current threshold. The current threshold can be determined based on a maximum allowable power transfer between the first electric machine 206 and the second electric machine 208.

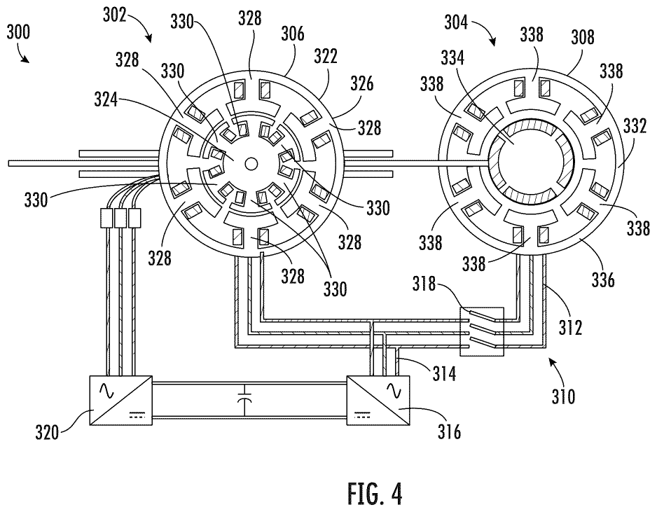

Now referring to FIG. 4, a schematic view of another power transfer system 300 is shown. Specifically, a first pressure spool 302 is an HP spool, a second pressure spool 304 is an LP spool, a first electric machine 306 is a DFM, and a second electric machine 308 is a PMSM. An electrical connector 310 includes a main portion 312 that connects the first electric machine 306 directly to the second electric machine 308 and a branch portion 314 that connects the second electric machine 308 to a power converter 316. The electrical connector 310 may include a circuit breaker 318, as described above. A second power converter 320 is connected to the first electric machine 306 and to the power converter 316. The power converter 316 and the second power converter 320 may be AC/AC converters. Additionally, the second power converter 320 may be current-controlled.

The first electric machine 306 includes a first stator 322 and a first rotor 324. The main portion 312 of the electrical connector 310 is connected to the first stator 322. Specifically, a plurality of wires of the electrical connector 310 are connected to one or more of first windings 326 of the first stator 322 at respective attachment points 328. The second power converter 320 includes a plurality of wires that are connected to the first rotor 324 at respective attachment points 330.

The second electric machine 308 includes a second stator 332 and a second rotor 334, and a plurality of wires of the electrical connector 310 are connected to the second stator 332. Specifically, each of the plurality of wires is connected one or more second windings 336 of the second stator at respective attachment points 338. The second rotor 334 is rotatable within the second stator 332 to generate or receive electric power.

By using a DFM as one of a set of electric machines of a hybrid-electric gas turbine engine, electrical output remains consistent as rotation of pressure spools changes. The direct connection between stators of the electric machines allows for increased power transfer without needing power converters with high voltage ratings. Such power transfer reduces losses between the pressure spools, increasing efficiency of the gas turbine engine.

Further aspects are provided by the subject matter of the following clauses:

A power transfer system includes a first pressure spool of a gas turbine engine structured to rotate and compress a working fluid to a first pressure, a first electric machine connected to the first pressure spool, the first electric machine including a first stator, a second pressure spool of the gas turbine engine structured to rotate and compress the working fluid to a second pressure different than the first pressure, a second electric machine connected to the second pressure spool, the second electric machine including a second stator, a first power converter connected to one of the first electric machine or the second electric machine, and an electrical connector including a main portion connecting the first stator of the first electric machine to the second stator of the second electric machine while bypassing the first power converter and a branch portion connecting the main portion to the first power converter.

The power transfer system of any of the preceding clauses, further including a second power converter electrically connected to the one of the first stator or the second stator.

The power transfer system of any of the preceding clauses, wherein the first power converter is electrically connected to the second power converter.

The power transfer system of any of the preceding clauses, wherein the electrical connector is configured to transfer power between the first electric machine and the second electric machine.

The power transfer system of any of the preceding clauses, wherein the first pressure spool is configured to generate mechanical power and the first electric machine is configured to convert the mechanical power into electrical power transferrable to the second electric machine via the main portion of the electrical connector.

The power transfer system of any of the preceding clauses, wherein the first pressure spool is a high pressure spool.

The power transfer system of any of the preceding clauses, wherein the second pressure spool is a low pressure spool.

The power transfer system of any of the preceding clauses, wherein the first pressure spool is a low pressure spool.

The power transfer system of any of the preceding clauses, wherein one of the first electric machine or the second electric machine is a doubly fed electric machine including a first set of windings and a second set of windings.

The power transfer system of any of the preceding clauses, further including a second power converter connected to the first power converter, wherein the main portion of the electrical connector is connected to the first set of windings and the second power converter is connected to the second set of windings.

The power transfer system of any of the preceding clauses, wherein the other of the first electric machine or the second electric machine is a permanent magnet synchronous machine.

The power transfer system of any of the preceding clauses, further including a circuit breaker configured to disconnect the first electric machine from the second electric machine.

The power transfer system of any of the preceding clauses, wherein the first electric machine is configured to provide power to the second electric machine via the main portion of the electrical connector.

The power transfer system of any of the preceding clauses, wherein the first pressure spool is configured to provide power to the second pressure spool via the first electric machine, the main portion of the electrical connector, and the second electric machine.

The power transfer system of any of the preceding clauses, wherein the main portion of the electrical connector is configured to transfer power from the first electric machine to the second electric machine and from the second electric machine to the first electric machine.

The power transfer system of any of the preceding clauses, wherein the first pressure spool includes a first pressure shaft and the second pressure spool includes a second pressure shaft, and the first pressure shaft and the second pressure shaft are concentric about a common axis.

The power transfer system of any of the preceding clauses, wherein the second electric machine is configured to output a constant current when a rotational speed of the first pressure spool changes.

The power transfer system of any of the preceding clauses, wherein the first power converter is an AC/AC electric converter.

The power transfer system of any of the preceding clauses, wherein the main portion of the electrical connector is configured to transfer more power from the first electric machine to the second electric machine than the first power converter.

A gas turbine engine includes a power transfer system including a first pressure spool structured to rotate and compress a working fluid to a first pressure, a first electric machine connected to the first pressure spool, the first electric machine including a first stator, a second pressure spool structured to rotate and compress the working fluid to a second pressure different than the first pressure, a second electric machine connected to the second pressure spool, the second electric machine including a second stator, a first power converter connected to one of the first electric machine or the second electric machine, and an electrical connector including a main portion connecting the first stator of the first electric machine to the second stator of the second electric machine while bypassing the first power converter and a branch portion connecting the main portion to the first power converter.

The gas turbine engine of any of the preceding clauses, further including a second power converter electrically connected to the one of the first stator or the second stator.

The gas turbine engine of any of the preceding clauses, wherein the first power converter is electrically connected to the second power converter.

The gas turbine engine of any of the preceding clauses, wherein the electrical connector is configured to transfer power between the first electric machine and the second electric machine.

The gas turbine engine of any of the preceding clauses, wherein the first pressure spool is configured to generate mechanical power and the first electric machine is configured to convert the mechanical power into electrical power transferrable to the second electric machine via the main portion of the electrical connector.

The gas turbine engine of any of the preceding clauses, wherein the first pressure spool is a high pressure spool.

The gas turbine engine of any of the preceding clauses, wherein the second pressure spool is a low pressure spool.

The gas turbine engine of any of the preceding clauses, wherein the first pressure spool is a low pressure spool.

The gas turbine engine of any of the preceding clauses, wherein one of the first electric machine or the second electric machine is a doubly fed electric machine including a first set of windings and a second set of windings.

The gas turbine engine of any of the preceding clauses, further including a second power converter connected to the first power converter, wherein the main portion of the electrical connector is connected to the first set of windings and the second power converter is connected to the second set of windings.

The gas turbine engine of any of the preceding clauses, wherein the other of the first electric machine or the second electric machine is a permanent magnet synchronous machine.

The gas turbine engine of any of the preceding clauses, further including a circuit breaker configured to disconnect the first electric machine from the second electric machine.

The gas turbine engine of any of the preceding clauses, wherein the first electric machine is configured to provide power to the second electric machine via the main portion of the electrical connector.

The gas turbine engine of any of the preceding clauses, wherein the first pressure spool is configured to provide power to the second pressure spool via the first electric machine, the main portion of the electrical connector, and the second electric machine.

The gas turbine engine of any of the preceding clauses, wherein the main portion of the electrical connector is configured to transfer power from the first electric machine to the second electric machine and from the second electric machine to the first electric machine.

The gas turbine engine of any of the preceding clauses, wherein the first pressure spool includes a first pressure shaft and the second pressure spool includes a second pressure shaft, and the first pressure shaft and the second pressure shaft are concentric about a common axis.

The gas turbine engine of any of the preceding clauses, wherein the second electric machine is configured to output a constant current when a rotational speed of the first pressure spool changes.

The gas turbine engine of any of the preceding clauses, wherein the first power converter is an AC/AC electric converter.

The gas turbine engine of any of the preceding clauses, wherein the main portion of the electrical connector is configured to transfer more power from the first electric machine to the second electric machine than the first power converter.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A power transfer system comprising:
a first pressure spool of a gas turbine engine structured to rotate and compress a working fluid to a first pressure;
a first electric machine connected to the first pressure spool, the first electric machine including a first stator;
a second pressure spool of the gas turbine engine structured to rotate and compress the working fluid to a second pressure different than the first pressure;
a second electric machine connected to the second pressure spool, the second electric machine including a second stator;
a first power converter connected to one of the first electric machine or the second electric machine; and
an electrical connector including a main portion connecting the first stator of the first electric machine to the second stator of the second electric machine while bypassing the first power converter and a branch portion connecting the main portion to the first power converter.

2. The power transfer system of claim 1, further comprising a second power converter electrically connected to one of the first stator or the second stator.

3. The power transfer system of claim 2, wherein the first power converter is electrically connected to the second power converter.

4. The power transfer system of claim 1, wherein the electrical connector is configured to transfer power between the first electric machine and the second electric machine.

5. The power transfer system of claim 4, wherein the first pressure spool is configured to generate mechanical power and the first electric machine is configured to convert the mechanical power into electrical power transferrable to the second electric machine via the main portion of the electrical connector.

6. The power transfer system of claim 1, wherein the first pressure spool is a high pressure spool.

7. The power transfer system of claim 6, wherein the second pressure spool is a low pressure spool.

8. The power transfer system of claim 1, wherein the first pressure spool is a low pressure spool.

9. The power transfer system of claim 1, wherein one of the first electric machine or the second electric machine is a doubly fed electric machine including a first set of windings and a second set of windings.

10. The power transfer system of claim 9, further comprising a second power converter connected to the first power converter, wherein the main portion of the electrical connector is connected to the first set of windings and the second power converter is connected to the second set of windings.

11. The power transfer system of claim 9, wherein the other of the first electric machine or the second electric machine is a permanent magnet synchronous machine.

12. The power transfer system of claim 1, further comprising a circuit breaker configured to disconnect the first electric machine from the second electric machine.

13. The power transfer system of claim 1, wherein the first electric machine is configured to provide power to the second electric machine via the main portion of the electrical connector.

14. The power transfer system of claim 13, wherein the first pressure spool is configured to provide power to the second pressure spool via the first electric machine, the main portion of the electrical connector, and the second electric machine.

15. The power transfer system of claim 1, wherein the main portion of the electrical connector is configured to transfer power from the first electric machine to the second electric machine and from the second electric machine to the first electric machine.

16. The power transfer system of claim 1, wherein the first pressure spool includes a first pressure shaft and the second pressure spool includes a second pressure shaft, and the first pressure shaft and the second pressure shaft are concentric about a common axis.

17. The power transfer system of claim 1, wherein the second electric machine is configured to output a constant current when a rotational speed of the first pressure spool changes.

18. The power transfer system of claim 1, wherein the first power converter is an AC/AC electric converter.

19. The power transfer system of claim 1, wherein the main portion of the electrical connector is configured to transfer more power from the first electric machine to the second electric machine than the first power converter.

20. A gas turbine engine comprising the power transfer system of claim 1.
